(19) United States
(12) Patent Application Publication
(10) Pub. No.: US 2011/0070384 A1
(43) Pub. Date: Mar. 24, 2011

(54) WRAP-AROUND LABEL, LABEL STOCK AND LABEL PROCESSING

(75) Inventor: Gregory S. Bentley, Uccle (BE)

(73) Assignee: The Coca-Cola Company, Atlanta, GA (US)

(21) Appl. No.: 12/881,433

(22) Filed: Sep. 14, 2010

(30) Foreign Application Priority Data
Sep. 18, 2009 (GB) 0916391.6
May 11, 2010 (GB) 1007851.7

(51) Int. Cl. B32B 1/02; B32B 38/04; B32B 38/00; B32B 3/04

(52) U.S. Cl. 428/34.1; 156/256; 156/227; 428/121

(57) ABSTRACT

The invention is concerned with a wrap-around labelstock comprising a web material having a machine direction (MD) and a transverse direction (TD), the web material comprising an MD fold, with a label severed from such a labelstock, with a container or other form of article labelled with such a label, and with a process for labelling a container or other form of article comprising: providing a labelstock comprising a web material having a machine direction (MD) and a transverse direction (TD), the web material comprising an MD fold; severing a label from the labelstock; applying an adhesive to the label; and adhering the label to the container or other form of article.

### RELATED APPLICATIONS

This application claims priority from United Kingdom Patent Application No. 0916391.6 filed 18 Sep. 2009 and from United Kingdom Patent Application No. 1007851.7 filed 11 May 2010.

### BACKGROUND OF THE INVENTION

### Field of the Invention

The present invention concerns a label, in particular a wrap-around label which is folded prior to application in order to provide an enlarged print-carrying surface area.

A label serves many functions, in particular with regard to branding and product origin indication, and also in connection with product information, much of such information being required or obligated by regulatory protocol. Manufacturers also seek to use labels to carry additional marketing or promotional material, but very often the space for such material is limited. Additional space on a label can be provided by folding the label and printing such material on its inside. Removal and unfolding of the label permits viewing of such material.

Certain types of folded label are known, for example in U.S. Pat. No. 6,162,158, EP2040242A1, EP684130B1, EP1882635A2, EP506202B1, EP1604343A1, EP1916646A2 and EP1781462B1.

However, none of these prior art labels are wholly suitable for application to containers as part of a rapid in-line wrap-around labelling process.

### SUMMARY OF THE INVENTION

According to the present invention there is provided a wrap-around labelstock comprising a web material having a machine direction (MD) and a transverse direction (TD), the web material comprising an MD fold.

In this specification MD has the normal meaning assigned in the art but may also or instead refer to the direction of reel unwinding when the labelstock is recovered from a web material reel. Typically the web material is an elongate web having a longitudinal direction which equates to the machine direction. “Wrap-around label” is a term of art and is distinguished from other types of labelling, such as shrink sleeve or sleeve labelling. By “wrap-around labelstock” is meant a labelstock which is configured for wrap-around labelling applications, as opposed to sleeve labelling applications. Such a labelstock, or a label severed therefrom, is typically sheet-form rather than tube-form, having a leading edge which first makes contact with a container being labelled and a trailing edge which is passed around the container only once the leading edge has been secured to the container, generally by means of an adhesive. In the resulting wrap-around label, the trailing edge extends around the container towards the leading edge, and may even overlap the leading edge,

The web preferably has an A side and a B side and the fold is preferably an A to A fold.

A plurality of MD folds may be provided if desired, in which case a combination two or more of A to A folds, B to B folds and/or A to B folds may be used.

It is also possible for the web to incorporate one or more TD folds.

Prior to the provision of the MD fold, the labelstock manufacturer or the converter may use the A side of the web as a vehicle for carrying printed or other information. In its final application on a container the A side and the information carried thereon will be at least partially hidden from view, but the label can be peeled from the container and unfolded to view the hidden information.

Consequently, the web preferably carries printed or other information inside the fold.

The web will of course typically carry printed or other information on its outside as well, so as to be directly visible when applied to a container.

Any suitable material may be used for the web, including but not limited to paper, plastics materials such as polypropylene, polyethylene and other polyolefins, polyesters, PVC and biopolymers such as cellulosic materials and PLA. Any such materials may be monowebs or laminate structures and may carry one or more coatings or may be otherwise treated, by corona discharge for example, to aid printability.

Also provided in accordance with the invention is a label severed from the labelstock as described above.

Typically the label will be severed from the labelstock along the TD.

The label is preferably provided with an adhesive component. Generally speaking, adhesive will be applied to the label during the labelling process of the invention, normally immediately prior to application of the label to the container. It is of course possible instead or as well to apply adhesive to the container in order to secure the label on the container.

The label preferably has a leading edge which makes first contact with a container during its application, and a trailing edge. Preferably an adhesive material is applied at least to the back of the label in the region of its trailing edge. Also preferably, an adhesive material is applied at least to the back of the label in the region of its leading edge.

The “back” of the label in this context is to be understood to mean that side of the folded label which makes contact with the container.

The adhesive material may be any suitable material such as a cold seal adhesive, a hot melt adhesive, a heat seal lacquer, a pressure sensitive adhesive or a wet glue, or any suitable combination thereof. It is also envisaged that the label itself may be sealable—for example by the provision of a heat seal coating thereon. Preferably in that case, the label is also peelable either by separable layers or by peeling within a layer by means of providing in the said layer a suitable peelable material such as a block copolymer.

The label of the invention may be provided with one or more tear-off portions, conveniently facilitated by the use of perforations or lines of weakness provided in the label in the MD and/or the TD. Typically such perforations or lines of weakness will be provided in the labelstock prior to severance of the label therefrom, but it is also possible for a severed label to be provided with such perforations or lines of weakness after severing of the label from the web material.

Also provided in accordance with the invention is a container or other form of article labelled with the label as described above.

The container is preferably a bottle.

Preferably the label wraps around the container and seals to itself. The label may also or instead seal to the container.

Also in accordance with the invention there is provided a process for labelling a container or other form of article comprising:
a) providing a wrap-around labelstock comprising a web material having a machine direction (MD) and a transverse direction (TD), the web material comprising an MD fold;
b) severing a label from the labelstock;
c) applying an adhesive to the label and/or the container or other form of article; and
d) adhering the label to the container or other form of article.

Preferably, the process of the invention comprises providing the label with a leading edge and a trailing edge, adhering the leading edge of the label to the container and passing the trailing edge around the container towards the leading edge, optionally to overlap with the leading edge having passed around the container, and adhering the trailing edge to the container and/or to the label in a region of overlap.

Preferably the process of the invention is a process wherein the unfolded web material is continuously fed to a printing station where it is printed on one or both sides, and then, optionally indirectly, to a folding station where it is folded in the MD in a manner which at least partially hides from view at least some of the print.

It will be understood that folding may take place directly after printing or after further processing and/or storage/transportation steps. For example, the printed web may be wound onto a reel and then, optionally at a different location, unwound to a folding station. Typically the web will be printed across its TD with a multiplicity of identical images, the web then being split along the MD between pairs of images to provide a plurality of individually printed labelstocks. These may be wound onto individual reels. Thus, directly after printing the printed web may be slit and wound onto a plurality of reels, and then fed from those reels to the folding station. Alternatively, the folding and slitting processes may be combined. Also alternatively, the printed web may be slit and wound onto reels, which may then be unwound to a folding station immediately prior to application of the label to the container in a cutting and gluing step. Consequently, the folding step may be combined with the printing step, or it may be combined with the application step, or it may be conducted separately.

The foregoing and other objects, features and advantages of the invention will become more readily apparent from the following detailed description of preferred embodiments, which proceeds with reference to the drawings.

### BRIEF DESCRIPTION OF THE DRAWINGS

FIG. 1 shows in schematic form a process for labelling of a bottle with a label according to the invention;

FIG. 2 shows in side elevation the labelled area of the bottle with three different label types, all in accordance with the invention; and

FIG. 3 shows in schematic form part of the process for producing the label in accordance with the invention wherein a printed label web is folded at a folding station.

FIG. 4 shows in schematic form part of an alternative process for producing a label in accordance with the invention wherein a folded labelstock is provided on a reel for subsequent use.

### DETAILED DESCRIPTION OF THE PREFERRED EMBODIMENTS

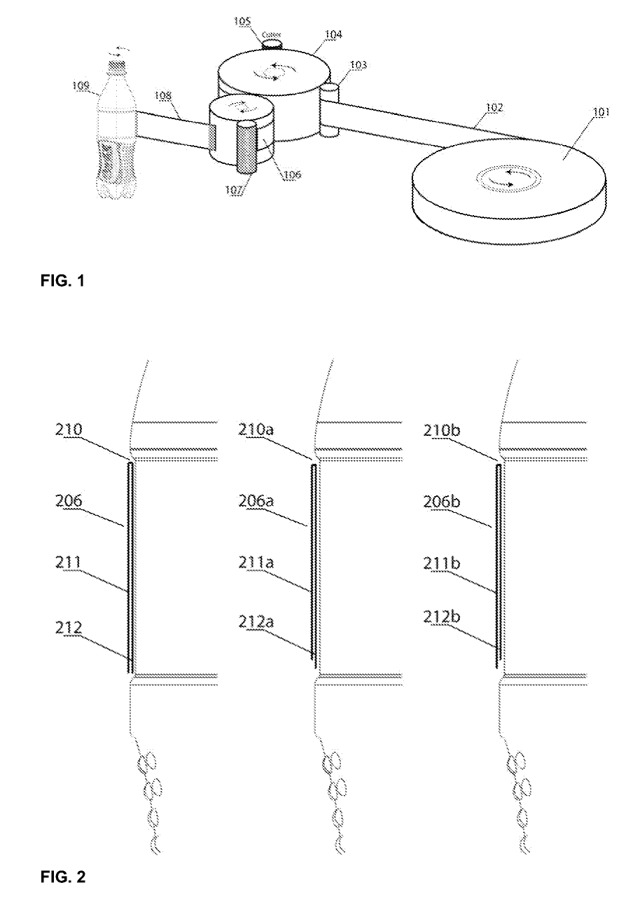

Referring to FIG. 1 there is shown reel 101 of labelstock 102 which is folded in half along the MD, the fold not being visible in FIG. 1. In a labelling process in accordance with the invention labelstock 102 is fed from reel 101 between rollers 103 and 104 and to cutting device 105 which severs individual labels from labelstock 102. Severed label 106 is shown proceeding around roller 104 to glue applicator 107 which in this case deposits a TD strip of hot melt adhesive on the back of label 106 in the region of both its leading and trailing edges. Resulting adhesive label 108 is fed to a labelling line (not shown) where it is wrapped around bottle 109, the leading edge of label 106 adhering to bottle 109 and being wrapped around bottle 109 to seal again to itself by its trailing edge (not shown in FIG. 1).

With reference to FIG. 2 applied label 206; 206a; 206b is shown adhered to bottle 209. In each of the three embodiments of the invention depicted in FIG. 2 label 206; 206a; 206b is shown having a single fold 210; 210a; 210b in the MD. In the first embodiment fold 210 is positioned such that two folded panels 211 and 212 of label 206 are symmetrically disposed about fold 210. In the second embodiment two folded panels 211 a and 212a of label 206a are symmetrically offset with respect to fold 210a such that rearmost panel 212a is slightly longer than foremost panel 211 a. In the third embodiment two folded panels 211 b and 212b of label 206b are symmetrically offset with respect to fold 210b such that foremost panel 212b is slightly longer than rearmost panel 211b. The second and third embodiments may in some cases be preferred because of the practical difficulty in ensuring a perfectly symmetrical fold as seen in the first embodiment. Of the second and third embodiments, the second is preferred for ease of peeling the label from the bottle, the second embodiment allowing easier access to the rearmost panel for peeling purposes.

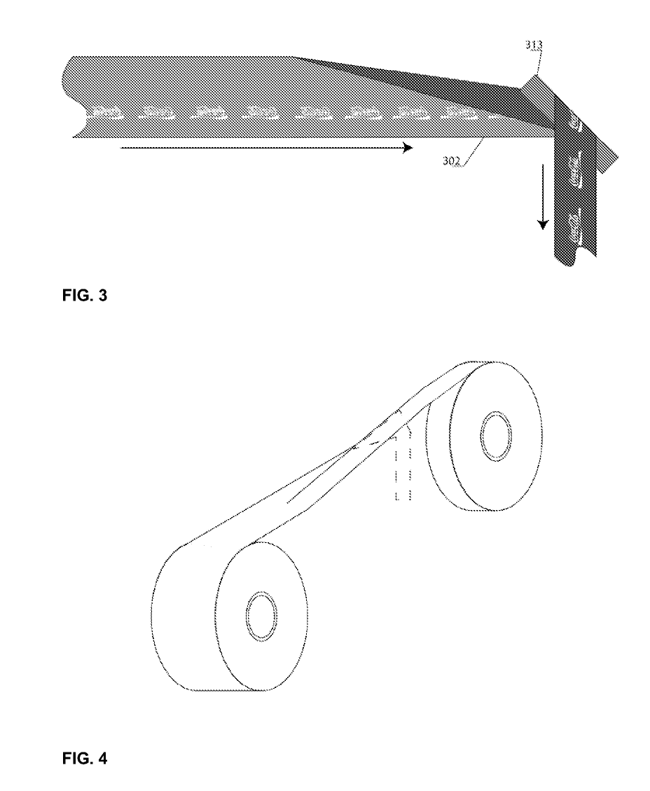

With reference to FIG. 3 there is shown a part of a labelling process according to the invention in which printed labelstock 302 is fed to folding bar 313 and onto a reel (not shown in FIG. 3) or directly into the cutting, gluing and labelling process as described above in connection with FIG. 1.

FIG. 4 shows part of a labelling process according to the invention in which a label stock is fed from a first reel to a folding bar and then on, in folded form, to a second reel for subsequent use.

In use, it is envisaged that the label will be applied, generally in wrap-around form to a container such as a drinks bottle and sealed to itself and/or to the container in a manner effective to secure the label during its normal commercial life, but also in a manner which allows the label to be peeled from the container and either wholly removed or removed sufficiently to permit the MD fold to be unfolded and the printed or other information carried on the erstwhile hidden folded side to be viewed. Typically the label will be printed on its exterior surface with some form of instruction or suggestion to the consumer to remove the label in the aforesaid manner, and consequently the label of the invention may be used as a means of communicating with customers additional information, which ordinarily space on the label would not permit, such as promotional, marketing, informational, educational or other useful information.

Having illustrated and described the principles of the invention in preferred embodiments thereof, it should be readily apparent to those skilled in the art that the invention can be modified in arrangement and detail without departing from such principles. All modifications coming within the spirit and scope of the accompanying claims are included.

What is claimed is:

1. A wrap-around labelstock comprising a web material having a machine direction (MD) and a transverse direction (TD), the web material comprising an MD fold.

2. A labelstock according to claim 1 wherein the web has an A side and a B side, and the fold is A to A fold.

3. A labelstock according to claim 1 wherein a plurality of MD folds are be provided.

4. A labelstock according to claim 3 wherein the plurality of MD folds comprises two or more of A to A folds, B to B folds and/or A to B folds.

5. A labelstock according to claim 1 wherein the web incorporates one or more TD folds.

6. A labelstock according to claim 1 wherein the web carries printed or other information inside the fold.

7. A labelstock according to claim 6 wherein the web additionally carries printed or other information on its outside, so as to be directly visible when applied to a container.

8. A label severed from the labelstock according to claim 1.

9. A label according to claim 8 severed from the labelstock along the TD.

10. A label according to claim 8 provided with an adhesive component.

11. A label according to claim 10 having a leading edge and a trailing edge, adhesive material being applied at least to the back of the label in the region of its trailing edge.

12. A label according to claim 11 wherein an adhesive material is applied at least to the back of the label in the region of its leading edge.

13. A label according to claim 8 provided with one or mores lines of weakness or perforation to provide one or more tear-off label portions.

14. A container or other form of article labelled with the label according to claim 8.

15. A container according to claim 14 being a bottle.

16. A container according to claim 14 wherein the label wraps around the container and seals to itself and/or the container.

17. A process for labelling a container or other form of article comprising:
a. providing a wrap-around labelstock comprising a web material having a machine direction (MD) and a transverse direction (TD), the web material comprising an MD fold;
b. severing a label from the labelstock;
c. applying an adhesive to the label and/or to the container or other form of article; and
d. adhering the label to the container or other form of article.

18. A process according to claim 17 being a process wherein the unfolded web material is continuously fed to a printing station where it is printed on one or both sides, and then, optionally indirectly, to a folding station where it is folded in the MD in a manner which at least partially hides from view at least some of the print.

19. A process according to claim 18 comprising providing the label with a leading edge and a trailing edge, adhering the leading edge of the label to the container and passing the trailing edge around the container towards the leading edge, optionally to overlap with the leading edge having passed around the container, and adhering the trailing edge to the container and/or to the label in a region of overlap.

20. A process according to claim 18 wherein the unfolded web material is continuously fed to a printing station where it is printed on one or both sides, and then, optionally indirectly, to a folding station where it is folded in the MD in a manner which at least partially hides from view at least some of the print.

21. A process according to claim 18 for providing a labelled container according to claim 14.
